(19) United States
(12) Patent Application Publication
(10) Pub. No.: US 2021/0352141 A1
(43) Pub. Date: Nov. 11, 2021

(54) Method And Device For Reaching Consensus In Parachain, And Storage Medium

(71) Applicant: JIANGSU FUZAMEI TECHNOLOGY CO., LTD., Suzhou (CN)

(72) Inventors: Zhiwen WANG, Suzhou (CN); Sijin WU, Suzhou (CN)

(21) Appl. No.: 17/272,626

(22) PCT Filed: Aug. 26, 2019
(86) PCT No.: PCT/CN2019/102507

§ 371 Date: Mar. 1, 2021

(30) Foreign Application Priority Data
Aug. 30, 2018 (CN) 201811005421.8

(51) Int. Cl. H04L 29/08; H04L 9/32; G06Q 10/06

(52) U.S. Cl. CPC H04L 67/1065; H04L 67/108; H04L 9/32; H04L 2209/56; H04L 2209/38; H04L 2209/463; G06Q 10/0637

(57) ABSTRACT

A method for reaching consensus in parachain includes the steps of: packaging a plurality of information of first blocks requiring consensus in a first parachain to generate first block information; transmitting he first block information to a corresponding node in a main chain for storing and recording the first block information in the main chain, and verifying the first block information stored and recorded in the main chain whether a number of first block information is not less than a first threshold number with the same information, to generate a consensus result; and synchronizing the consensus result, and writing the first block to the first parachain when the first block passes the verification.

### BACKGROUND OF THE PRESENT INVENTION

### Field of Invention

The present invention relates to a field of Internet financial technology, and more particularly to a method and device for reaching consensus in parachain, and its storage medium.

### Description of Related Arts

A drawback of the existing parachain mechanism is that it cannot be guaranteed whether a block is corrected or not after the block is generated by a parachain node, such that the data of the parachain is unreliable. If consensus is directly made on the parachain, the parachain and a main chain will form two individual consensus block chains. Parachain requires a lot of resources to reach consensus.

### SUMMARY OF THE PRESENT INVENTION

In view of the above-mentioned drawbacks or deficiencies in the conventional art, it is desirable to provide a method and device for a parachain consensus and its storage medium, which can consume less resources and can ensure the accuracy of the parachain block.

In accordance with an aspect of the invention, the present invention provided a parachain consensus method which comprises the steps of:

packaging information of first blocks requiring consensus in a first parachain to generate first block information;

transmitting the first block information to a corresponding node in a main chain for storing and recording the first block information in the main chain, and verifying the first block information stored and recorded in the main chain whether a number of first block information is not less than a first threshold number with the same information, to generate a consensus result; and

synchronizing the consensus result, and writing the first block to the first parachain that passes a verification.

In accordance with another aspect of the invention, the present invention provided a parachain consensus method which comprises the steps of:

receiving first block information sent by the corresponding parachain node and record the first block information in the main chain, wherein the first block information of the first block is generated by the parachain node packaging the information of the first block; and

verifying the first block information stored and recorded in the main chain whether a number of first block information is not less than a first threshold number with the same information, to generate a consensus result for the parachain node and to synchronize the consensus result, and writing the first block to the first parachain that passes the verification.

In accordance with a third aspect of the invention, the present invention provided a device for parachain consensus, which comprises one or more processors and memories, wherein the memory contains instructions executable by the processors to enable a parachain consensus method being executed by the processor according to different embodiments of the present invention.

In accordance with a third aspect of the invention, the present invention provided a storage medium storing a computer program, which is executed by a computer to process a parachain consensus method according to different embodiments of the present invention.

The present invention provides a method and device for reaching consensus in parachain and its storage medium, wherein the first block information is generated by packaging a plurality of information of first blocks requiring consensus in a first parachain. The first block information is transmitted to a corresponding node in a main chain for storing and recording the first block information in the main chain. The first block information stored and recorded in the main chain is verified whether a number of first block information is not less than a first threshold number with the same information, to generate a consensus result. Then, the consensus result is synchronized, and the first block is written to the first parachain when the first block passes the verification. The present invention is able to solve the problem of the unreliable data of parachain and the huge resources consumption of parachain consensus.

The method and device for reaching consensus in parachain and its storage medium of the present invention further reduces the cost of parachain consensus, improves the performance of parachain, and optimizes user experience by configuring all parachain nodes as partial parachain nodes (parachain nodes configured as verification nodes).

### BRIEF DESCRIPTION OF THE DRAWINGS

FIG. 1 is a schematic diagram of a parachain consensus according to a preferred embodiment of the present invention.

FIG. 2 is a flow chart of a method of the parachain consensus for parachain nodes according to the above preferred embodiment of the present invention.

FIG. 3 is a flow chart of a method of the parachain consensus for main chain nodes according to the above preferred embodiment of the present invention.

FIG. 4 is a block diagram of the parachain consensus according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

It should be understood that the embodiments in the present invention and the features in the embodiments can be combined with each other without any conflict. These and other objectives, features, and advantages of the present invention will become apparent from the following detailed description and the accompanying drawings.

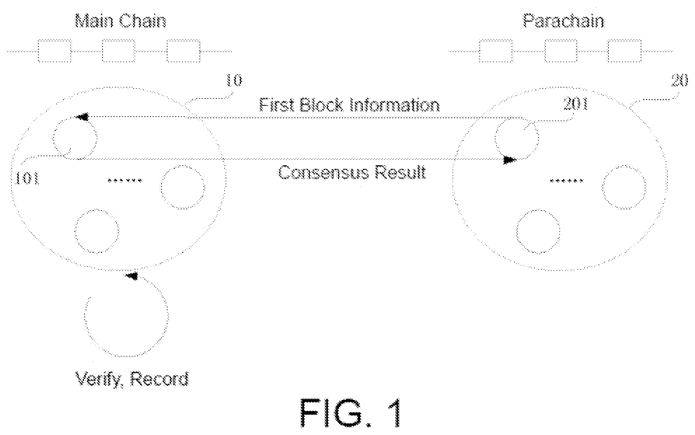

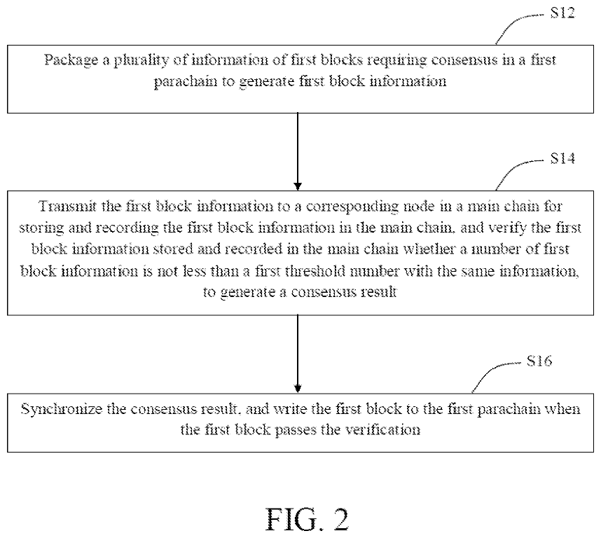

FIG. 1 is a schematic diagram of a parachain consensus according to a preferred embodiment of the present invention. As shown in FIG. 1, a parachain 20 has one or more parachain nodes 201 while a main chain 10 has one or more main chain modes 101, wherein the parachain node 201 is incorporated with the main chain mode 101 to form a parachain consensus method for the parachain 20. FIG. 2 illustrates the parachain consensus method with the following descriptions.

According to the preferred embodiment, the parachain consensus method as shown in FIG. 2, which is configured for parachain nodes, comprises the following steps.

S12: Package a plurality of information of first blocks requiring consensus in a first parachain to generate first block information.

S14: Transmit the first block information to a corresponding node in a main chain for storing and recording the first block information in the main chain, and verify the first block information stored and recorded in the main chain whether a number of first block information is not less than a first threshold number with the same information, to generate a consensus result.

S16: Synchronize the consensus result, and write the first block to the first parachain when the first block passes the verification.

Particularly, as an example as shown in FIG. 1, assuming that the first block requiring consensus in the first parachain is a block with a block height H in the first parachain, assuming that a plurality of information are state hashing of the first block, block height, signature information, and state information of each packaged transaction, and assuming that the consensus result is the state hashing of the first block, block height, state information of each packaged transaction, and authentication identifier.

In the step S12, the parachain node 201 is configured to pack a plurality of information of the first block requiring consensus in the first parachain 20 to generate the first block information. Since the first block requiring consensus in the first parachain is set as a block with a block height of H on the first parachain, the information is set as the state hashing of the first block, block height, signature information, and state information of each packaged transaction. Therefore, the parachain node 201 is configured to pack the state hashing, block height, signature information, and state information of each packaged transaction of the block with the block height H of the first parachain 20 to generate the first block information.

In the step S14, the parachain node 201 is configured to send the first block information to the corresponding main chain node 101, such that the main chain node 101 is configured to record the first block information in the main chain 10. The main chain node 101 is configured to verify the first block information stored and recorded in the main chain whether a number of first block information is not less than the first threshold number with the same information, so as to generate the consensus result. Since the consensus result is the state hashing of the first block, the block height, the state information of each packaged transaction, and the authentication identifier, the parachain node 201 is configured to send the first block information to the corresponding main chain node 101 for the main chain mode 101 to store the first block information in the main chain 10. The main chain node 101 is configured to verify the first block information stored and recorded in the main chain whether a number of first block information is not less than the first threshold number with the same information, so as to generate state hashing, the block height, the state information of each packaged transaction, and the authentication identifier of the first block.

In the step S16, the parachain node 201 is configured to synchronize the state hashing, the block height, the state information of each packaged transaction, and the authentication identifier of the first block, and is configured to write the first block into the first parachain 20 that pass the verification.

In the step S14, the main chain node 101 is configured to verify the first block information stored and recorded in the main chain whether a number of first block information is not less than the first threshold number with the same information. If the it cannot verify the first block information stored and recorded in the main chain whether a number of first block information is not less than the first threshold number with the same information, the consensus result will not be generated. If the parachain node 201 fails to synchronize the consensus result within the a predetermined timeout period, the first block will not be written to the first parachain 20.

In the above embodiment, the first block requiring consensus in the first parachain is set as the block with the block height of H in the first parachain. The plurality of information are the state hashing, block height, signature information, and state information of each packaged transaction and the authentication identifier of the first block as an example for the parachain consensus method of the present invention.

The parachain consensus method of the present invention should not be limited to the above example. In other examples, information can be at least one of one or more of the state hashing, block height, signature information, and state information of each packaged transaction of the first block. Ii can also be configured as block header hashing and other information according to actual needs, and the same technical result can be achieved.

According to the preferred embodiment, the parachain consensus method as shown in FIG. 2 is configured for verification node. Particularly, assumed that before the step S12 of the method shown in FIG. 2, the parachain nodes are divided into parachain consensus nodes and parachain verification nodes. The parachain consensus nodes are configured to process a business logic of the transaction information of the first block requiring consensus. The parachain verification nodes are configured to execute the method as shown in FIG. 2. According to the preferred embodiment, only portions of the parachain nodes (the parachain nodes configured as the parachain verification nodes) are configured to execute the method as shown in FIG. 2, to reduce the cost of parachain consensus, to improve the performance of parachains, and to optimize the user experience.

According to the preferred embodiment, the number of verification nodes is set as at least 3N+1, where N is a positive integer, and N is the number of verification nodes that allows the first block information to generate errors. Particularly, after the verification node is configured to execute the method shown in FIG. 2, BFT consensus algorithm is implemented to reach the consensus, wherein the BFT consensus algorithm is conditioned that the number of verification nodes is at least 3N+1, where N is a positive integer and N is the number of verification nodes that allows the first block information to generate errors. If N=1, the number of verification nodes is at least four. Assuming that there are 4 verification nodes, if the main chain node is configured to verify the first block information generated by the verification node stored and recorded in the main chain, and if there are more than or equal to three first block information with the same information, the consensus result will be generated. The verification node is configured to synchronize the consensus result and to write the first block into the first parachain after the first block is verified. According to the embodiment, the BFT consensus algorithm is used to reach the consensus, and the number of verification nodes is set at least 3N+1 as an example. In other embodiments, other consensus algorithms can be used for consensus and the configuration method of the verification node can also be altered according to the actual needs.

According to the preferred embodiment, the information contains at least one of the state hashing, block height, signature information, state information of each packaged transaction of the first block, wherein the status information is configured to identify whether each transaction packaged in the first block is successful or not. Particularly, assuming that the state information is in form of a key value table, wherein each transaction is configured with a first index as a key in the key value table. Each transaction is successfully packaged and configured with a binary value, wherein the binary value is the value in the key value table. For example, if the transaction with the first index of “1” is successfully packaged, the binary value of the transaction is configured as “1”. If the transaction with the first index of 1 fails to be packaged, then the binary value of the transaction is configured as “0”. Assuming that in the current block, there are 4 transactions with index values of 1, 2, 3, and 4 respectively, the package status of these 4 transactions are: success, success, success, failure, and the status information are: (1,1), (2,1), (3,1), (4,0). According to the preferred embodiment, the state information is in form of a key value table as an example. In other embodiments, the status information can also be configured as other tables or other data form according to the actual requirements. For example, the status information can also be configured as a “excel” form or matrix form to achieve the same technical result.

According to the preferred embodiment, the step S16 in the method as shown in FIG. 2 further comprises the steps of: synchronizing the consensus result, and during the verifying each block in the first block, writing the first block after verified in the first parachain when each block before the first block passes the verification.

According to the preferred embodiment, the consensus result comprises an authentication identifier configured for the first block that has passed the verification.

According to the preferred embodiment, the consensus result further comprises an authentication height of the first parachain determined in response to the authentication identifier, wherein the authentication height is recorded in the main chain. Particularly, assuming that the first block requiring consensus in the first parachain is set as a block with a block height of H in the first parachain, and the authentication height is set as the block height of the first block requiring consensus in the first parachain. The main chain node is configured to verify the first block information stored and recorded in the main chain whether a number of first block information is not less than the first threshold number with the same information, so as to generate the consensus result. Since the consensus result contains the authentication identifier configured for the first block that passed the verification, the main chain is configured to update the authentication height of the first parachain from “H-1” to “H” according to the authentication identifier, wherein the information of the first parachain with the authentication height of H is stored and recorded on the main chain.

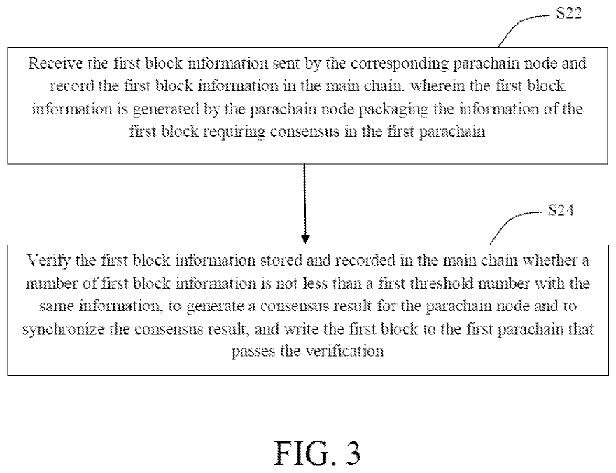

FIG. 3 is a flowchart of a parachain consensus method for main chain nodes, according to the preferred embodiment of the present invention. As shown in FIG. 3 of the preferred embodiment, the present invention provides a parachain consensus method, which is configured for main chain nodes, comprises the following steps.

S22: Receive the first block information sent by the corresponding parachain node and record the first block information in the main chain, wherein the first block information is generated by the parachain node packaging the information of the first block requiring consensus in the first parachain.

S24: Verify the first block information stored and recorded in the main chain whether a number of first block information is not less than a first threshold number with the same information, to generate a consensus result for the parachain node and to synchronize the consensus result, and write the first block to the first parachain that passes the verification.

Particularly, as an example shown in FIG. 1, assuming that the first block requiring consensus in the first parachain is set as a block with a block height of H in the first parachain, the information is set as the state hashing, block height, signature information, and state information of each packaged transaction of the first block, and the consensus result is set as the state hashing, the block height, the state information of each packaged transaction, and the authentication identifier of the first block.

In the step S22, the main chain node 101 is configured to receive the first block information sent by the corresponding parachain node 201, and to record the first block information on the main chain 10, wherein the first block information of the first block is generated by the parachain node packaging the information of the first block requiring consensus. Since the first block requiring consensus in the first parachain is set as a block with a block height of H in the first parachain, the information is set as the state hashing, block height, signature information, and state information of each packaged transaction of the first block, such that first block information is generated by the parachain node 201 packages the state hashing, block height, signature information, and state information of each packaged transaction of the first block of the first parachain with the block height H.

In the step S24, the main chain node 101 is configured to verify the first block information stored and recorded in the main chain whether a number of first block information is not less than a first threshold number with the same information, to generate a consensus result for the parachain node to synchronize the consensus result, and write the first block to the first parachain that passes the verification. Since the consensus result is set as the state hashing, the block height, the state information of each packaged transaction, and the authentication identifier of the first block, the main chain node 101 is configured to verify he first block information stored and recorded in the main chain whether a number of first block information is not less than a first threshold number with the same information, to generate the state hashing, block height, state information of each packaged transaction, and authentication identifier of the first block for the parachain node 201 to synchronize the state hashing, the block height, the state information of each packaged transaction, and the authentication identifier of the first block, and to write the first block to the first parachain 20 that passes the verification.

According to the preferred embodiment, the first block requiring consensus in the first parachain is set as the block with the block height of H in the first parachain. The information is set as the state hashing, block height, signature information, and state information of each packaged transaction of the first block. The consensus result is set as the state hashing, block height, and state information of each packaged transaction and authentication identifier of the first block. These conditions are taken as an example in the parachain consensus method of the present invention. In other embodiments, the parachain consensus method of the present invention should not be limited to the above example. The information can be configured as one or more of the state hashing, block height, signature information, and state information of each packaged transaction of the first block. Alternatively, the information can also be configured as block header hashing and other information according to the actual needs to achieve the same technical result.

In the step S24, the main chain node 101 is configured to verify the first block information stored and recorded in the main chain whether a number of first block information is not less than a first threshold number with the same information, to generate a consensus result. If the first block information cannot be verified that the number of first block information is not less than a first threshold number with the same information, the consensus result will be generated. If the parachain node 201 fails to synchronize the consensus result within the a predetermined timeout period, the first block will not be written to the first parachain 20.

According to the preferred embodiment, the consensus result contains an authentication identifier configured for the first block that passes the verification.

According to the preferred embodiment, the consensus result further contains an updated authentication height of the first parachain according to the authentication identifier, wherein the updated authentication height is stored and recorded in the main chain. Particularly, assuming that the first block requiring consensus in the first parachain is set as a block with a block height of H in the first parachain, and the authentication height is set as the block height of the first block requiring consensus in the first parachain. The main chain node is configured to verify the first block information stored and recorded in the main chain whether a number of first block information is not less than the first threshold number with the same information, so as to generate the consensus result. Since the consensus result contains the authentication identifier configured for the first block that passed the verification, the main chain is configured to update the authentication height of the first parachain from “H-1” to “H” according to the authentication identifier, wherein the information of the first parachain with the authentication height of H is stored and recorded on the main chain.

According to the preferred embodiment, the number of verification nodes is set as at least 3N+1, where N is a positive integer, and N is the number of verification nodes that allows the first block information to generate errors. Particularly, after the verification node is configured to execute the method shown in FIG. 2, BFT consensus algorithm is implemented to reach the consensus, wherein the BFT consensus algorithm is conditioned that the number of verification nodes is at least 3N+1, where N is a positive integer and N is the number of verification nodes that allows the first block information to generate errors. If N=1, the number of verification nodes is at least four. Assuming that there are 4 verification nodes, if the main chain node is configured to verify the first block information generated by the verification node stored and recorded in the main chain, and if there are more than or equal to three first block information with the same information, the consensus result will be generated. The verification node is configured to synchronize the consensus result and to write the first block into the first parachain after the first block is verified. According to the embodiment, the BFT consensus algorithm is used to reach the consensus, and the number of verification nodes is set at least 3N+1 as an example. In other embodiments, other consensus algorithms can be used for consensus and the configuration method of the verification node can also be altered according to the actual needs.

According to the preferred embodiment, the information contains at least one of the state hashing, block height, signature information, state information of each packaged transaction of the first block, wherein the status information is configured to identify whether each transaction packaged in the first block is successful or not. Particularly, assuming that the state information is in form of a key value table, wherein each transaction is configured with a first index as a key in the key value table. Each transaction is successfully packaged and configured with a binary value, wherein the binary value is the value in the key value table. For example, if the transaction with the first index of “1” is successfully packaged, the binary value of the transaction is configured as “1”. If the transaction with the first index of 1 fails to be packaged, then the binary value of the transaction is configured as “0”. Assuming that in the current block, there are 4 transactions with index values of 1, 2, 3, and 4 respectively, the package status of these 4 transactions are: success, success, success, failure, and the status information are: (1,1), (2,1), (3,1), (4,0). According to the preferred embodiment, the state information is in form of a key value table as an example. In other embodiments, the status information can also be configured as other tables or other data form according to the actual requirements. For example, the status information can also be configured as a “excel” form or matrix form to achieve the same technical result.

According to the preferred embodiment, the step S24 in the method as shown in FIG. 3 further comprises a step of writing the first block after verified in the first parachain only when each block before the first block passes the verification.

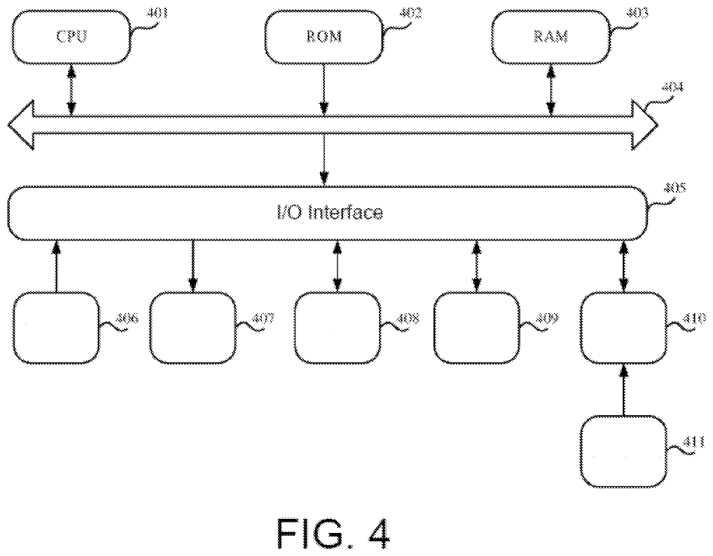

FIG. 4 is a schematic diagram of a device according to the preferred embodiment of the present invention.

As shown in FIG. 4, the present invention further provides a device 400 which comprises one or more central processing units (CPU) 401 configured to execute and process different programs stored in a read-only memory (ROM) 402 or programs loaded from a storage medium 408 into a random access memory (RAM) 403. Various programs and data required for the operation of the device 400 are also stored in the RAM 403. The CPU 401, the ROM 402, and the RAM 403 are operatively connected with each other through a bus 404. An input/output (I/O) interface 405 is also operatively connected to the bus 404.

The I/O interface 405 are also operatively connected to: an input unit 406 such as keyboard and mouse, an output unit 407 such as cathode ray tube (CRT), liquid crystal display (LCD), etc. and speakers, the storage medium 408 such as a hard disk, and a communication unit 409 such as a network interface card i.e. a LAN card, a modem, and the like. The communication unit 409 is configured to perform communication processing via a network such as the Internet. A driver 410 is also operatively connected to the I/O interface 405 as needed. A removable medium 411, such as a magnetic disk, an optical disk, a magneto-optical disk, a semiconductor memory, etc., is installed on the drive 410 as needed, such that the computer can read the installed into the storage medium 408 as needed.

Particularly, according to the preferred embodiment of the present invention, the parachain consensus method mentioned in any of the above embodiments can be implemented as a computer software program. For example, the above embodiments of the present invention can be a computer program product, which includes a tangibly machine-readable medium of a computer program, wherein the computer program contains program code for executing the parachain consensus method. According to the preferred embodiment, the computer program can be downloaded and installed via the network through the communication unit 409, and/or installed from the removable medium 411.

In another aspect, the present invention also provides a computer-readable storage medium which can be embodied as the computer-readable storage medium including the device of the above mentioned embodiment. It can also be a stand-alone medium and is not assembled into the device. The computer-readable storage medium is configured to store one or more programs, wherein the programs can be executed by one or more processors to perform the parachain consensus method described in the present invention.

The flowcharts and block diagrams in the accompanying drawings illustrate the implementation architecture, functions, and operations of the system, method, and computer program product according to the above mentioned embodiments of the present invention. Accordingly, each block in the flowchart or block diagram can represent a module, program segment, or a portion of code, wherein the module, program segment, or the portion of code contains one or more executable instructions for achieving the specified logical function. It should also be understood that, in other alternative implementations, the functions indicated in the block may also provide in a different order shown in the drawings. For example, two successive blocks can be executed in parallel. Alternatively they can be executed in the reverse order, depending on the corresponding functions. It is worth mentioning that each block in the block diagram and/or flowchart, and a combination of blocks in the block diagram and/or flowchart, can be implemented by a dedicated hardware-based system adapted to perform the specified functions or operations. Alternatively, it can be achieved by a combination of dedicated hardware and computer instructions.

The units or modules in the embodiments of the present invention can be implemented in software or hardware. The mentioned units or modules may also be arranged in the processor. For example, each of the mentioned units may be a software program arranged in a computer or a mobile smart device, or may be an individually configured hardware device. Accordingly, the names of these units or modules do not constitute any limitation on the units or modules themselves under certain circumstances.

The above description is disclosed to enable any person skilled in the art to make and use the present invention. It will thus be seen that the objects of the present invention have been fully and effectively accomplished. The embodiments have been shown and described for the purposes of illustrating the functional and structural principles of the present invention and is subject to change without departure from such principles. For example, the above-mentioned features and the technical features disclosed in the present invention (but not limited to) with similar functions are mutually replaced to form a technical solution.

1. A method for reaching consensus in parachain, which is configured for parachain nodes, comprising the steps of:
packaging information of first blocks requiring consensus in a first parachain to generate first block information;
transmitting the first block information to a corresponding node in a main chain for storing and recording the first block information in the main chain, and verifying the first block information stored and recorded in the main chain whether a number of first block information is not less than a first threshold number with the same information, to generate a consensus result; and
synchronizing the consensus result, and writing the first block to the first parachain after the first block passes a verification.

2. The method, as recited in claim 1, wherein the parachain nodes are divided into consensus nodes and verification nodes, wherein the consensus nodes are configured to process a business logic of transaction information of the first block requiring consensus, wherein the verification nodes are configured to synchronize the consensus result and to write the first block into the first parachain after the first block is verified.

3. The method, as recited in claim 2, wherein a number of the verification nodes is configured to be at least 3N+1, where N is a positive integer, and N is a number of the verification nodes that allows the first block of information to generate errors.

4. The method, as recited in claim 3, wherein the information contains at least one of state hashing, block height, signature information, and state information of each packaged transaction of the first block, wherein the state information is configured to identify whether each transaction packaged in the first block is successful or not.

5. The method, as recited in claim 3, wherein the synchronizing and writing step further comprises a step of:
synchronizing the consensus result, and writing the first block after verified in the first parachain when each block before the first block passes the verification.

6. The method, as recited in claim 3, wherein the consensus result comprises an authentication identifier configured for the first block that has passed verification.

7. The method, as recited in claim 6, wherein the consensus result further comprises an authentication height of the first parachain determined in response to the authentication identifier, wherein the authentication height is recorded in the main chain.

8. A method for reaching consensus in parachain, which is configured for main chain nodes, comprising the steps of:
receiving first block information sent by a corresponding parachain node and recording the first block information in a main chain, wherein the first block information is generated by a parachain node packaging a plurality of information of a first block requiring consensus in the first parachain; and
verifying the first block information stored and recorded in the main chain whether a number of first block information is not less than a first threshold number with the same information, to generate a consensus result for the parachain node and to synchronize the consensus result, and writing the first block to the first parachain that passes a verification.

9. The method, as recited in claim 8, wherein an authentication identifier is configured for the first block that has passed verification.

10. The method, as recited in claim 9, further comprising a step of:
updating an authentication height of the first parachain according to the authentication identifier, and recording the updated authentication height in the main chain.

11. The method, as recited in claim 10, wherein the parachain node is set as a verification node of the first parachain.

12. The method, as recited in claim 11, wherein a number of verification nodes is configured to be at least 3N+1, where N is a positive integer, and N is a number of the verification nodes that allows the first block of information to generate errors.

13. The method, as recited in claim 10, wherein the information contains at least one of state hashing, block height, signature information, and state information of each packaged transaction of the first block, wherein the state information is configured to identify whether each transaction packaged in the first block is successful or not.

14. The method, as recited in claim 10, wherein the first block after verified is only written in the first parachain only when each block before the first block passes a verification.

15. A device, comprising:
one or more processors; and
a memory that stores one or more programs;
wherein when one or more programs are executed by the one or more processors, the one or more processors are configured to:
package information of first blocks requiring consensus in a first parachain to generate first block information, wherein the first parachain has one or more parachain nodes:
transmit the first block information to a corresponding node in a main chain for storing and recording the first block information in the main chain, and verifying the first block information stored and recorded in the main chain whether a number of first block information is not less than a first threshold number with the same information, to generate a consensus result; and
synchronize the consensus result, and writing the first block to the first parachain after the first block passes a verification.

16. (canceled)

17. The device, as recited in claim 15, wherein the parachain nodes are divided into consensus nodes and verification nodes, wherein the consensus nodes are configured to process a business logic of transaction information of the first block requiring consensus, wherein a number of verification nodes is configured to be at least 3N+1, where N is a positive integer, and N is a number of the verification nodes that allows the first block of information to generate errors.

18. The device, as recited in claim 17, wherein the information contains at least one of state hashing, block height, signature information, and state information of each packaged transaction of the first block, wherein the state information is configured to identify whether each transaction packaged in the first block is successful or not.

19. The device, as recited in claim 17, wherein the one or more processors are further configured to synchronize the consensus result, and write the first block after verified in the first parachain when each block before the first block passes the verification.

20. The device, as recited in claim 17, wherein the consensus result comprises an authentication identifier configured for the first block that has passed verification.

21. The device, as recited in claim 20, wherein the consensus result further comprises an authentication height of the first parachain determined in response to the authentication identifier, wherein the authentication height is recorded in the main chain.
